(19) United States
(12) Patent Application Publication
(10) Pub. No.: US 2003/0158948 A1
(43) Pub. Date: Aug. 21, 2003

(54) Configuring communications over a network

(76) Inventor: Jonathan M. Walsh, Lexington, MA (US)

Correspondence Address: FISH & RICHARDSON, PC, 4350 LA JOLLA VILLAGE DRIVE, SUITE 500, SAN DIEGO, CA, 92122, US

(21) Appl. No.: 10/081,830

(22) Filed: Feb. 21, 2002

(51) Int. Cl. G06F 15/177

(52) U.S. Cl. 709/228; 709/250; 709/230

(57) ABSTRACT

A method of configuring communications over a network includes connecting a device to a network and receiving data, on the device, from the network. The device determines a communication mode, from numerous possible communication modes, for transferring data between the device and the network. The communication mode includes transferring data between the device and the network simultaneously in time. Then, based on the determined communication mode, data transfers between the device and the network. The device then determines whether to retain the communication mode.

### TECHNICAL FIELD

This application relates to configuring communications over a network.

### BACKGROUND

Networks, such as a local area network (LAN) transmit information between computers using Ethernet. Computers may connect to the Ethernet by various media including thick coaxial lines, thin coaxial lines, twisted pair lines, and fiber optic lines. Once connected, each computer may seek to transmit information over the Ethernet. A set of medium access control rules maybe embedded in each computer's Ethernet interface to regulate access to the Ethernet to avoid multiple transmission interference.

### DESCRIPTION OF DRAWINGS

FIG. 1 illustrates a block diagram of an Ethernet network.

FIG. 2 illustrates a flow diagram of an auto-negotiation protocol.

FIG. 3 illustrates a view of computer hardware used to implement one embodiment of this invention.

Like reference symbols in the various drawings indicate like elements.

### DESCRIPTION

As will be described in greater detail below, a method of configuring communications over a network includes connecting a device to the network and receiving data, on the device, from the network. The device determines a communication mode, from a plurality of possible communication modes, for transferring data to and from the network. The communication mode includes transferring data between the device and the network simultaneously in time. Data is then transferred between the device and the network in accordance with the determined communication mode. The device then determines whether to retain the communication mode.

By determining whether the device can simultaneously transmit and receive data over the connected network, the device can determine whether the network is operating in a half-duplex mode or a full-duplex mode. If operating in a full-duplex mode, the network simultaneously sends data to and receives data from the device. Alternatively, if operating in half-duplex mode the network transmits data to and receives data from the device at separate and distinct intervals.

Once connected to the network, the device executes a procedure, known as an auto-negotiation protocol, that exchanges information between the network and the device, to determine the most appropriate communication mode. The device receives Fast Link Pulses (FLP) from the network, which provide the information to the auto-negotiation protocol. Once the most appropriate communication mode is determined, the device may be configured for that communication mode.

However, the Institute of Electrical and Electronic Engineers standard, “IEEE 802.3 Carrier Sense Multiple Access with Collision Detection (CSMA/CD) Access Method and Physical Layer Specification, section 28.2.3.1” published in 1985, directs the auto-negotiation protocol to configure the device for half-duplex mode regardless of the duplex mode of the network.

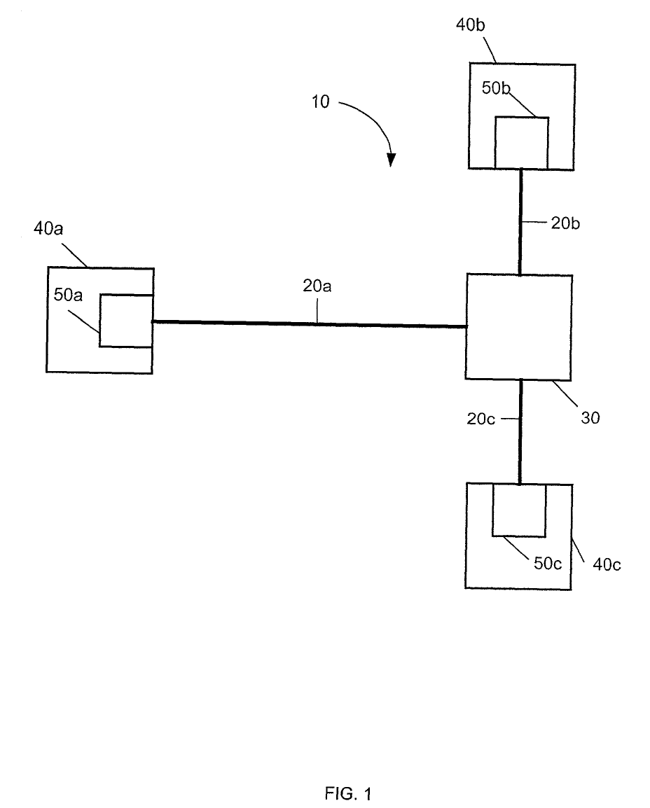

Referring to FIG. 1, an Ethernet network 10 includes Ethernet cable 20a that connects computer 40a to hub 30 and allows information to be passed between the computer and the hub. Computer 40a includes Ethernet interface card 50a that connects Ethernet cable 20a to computer 40a and manages information transfers between the computer and hub 30. Hub 30, is a computer that regulates communications between connected computers 40a, 40b, and 40c, thereby allowing information to be passed between all three computers 40a-c over Ethernet network 10. In particular, Ethernet cables 20b and 20c connect computers 40b and 40c via Ethernet interface cards 50b and 50c. Thus, computer 40a may transfer information to hub 30 with a single transmission for broadcasting to computers 40b and 40c.

To achieve high performance while transferring information between computer 40a and hub 30, Ethernet interface card 50a maybe configured to match the transmission and reception parameters of hub 30. For example, when connecting computer 40a to hub 30, Ethernet interface card 50a determines how fast hub 30 transmits and receives data. By determining this speed, computer 40a may select a communication mode for efficiently communicating with hub 30, and all the devices connected to Ethernet network 10.

To determine the most appropriate communication mode and configure itself for communicating with hub 30, Ethernet interface card 50a executes an auto-negotiation protocol that samples FLP signals received from hub 30. The FLP signals contain information describing the data transmission and reception of hub 30. The FLP signals are also transmitted by hub 30 during idle times and do not interfere with the normal Ethernet network 10 traffic. By executing the auto-negotiation protocol, Ethernet interface card 50a negotiates between the hub's communication mode, determined from the FLP signals, and the card's own possible communication modes for the most appropriate selection.

The data transmission and reception information, in the FLP signals, provide the communication mode of hub 30 based on the IEEE standard mentioned above. However, IEEE 802.3 section 28.2.3.1 requires that, “When selecting the highest common denominator through the Parallel Detection function, only the half-duplex mode corresponding to the selected PMA (Physical Medium Attachment) may automatically be detected.” In other words, when the auto-negotiation protocol executes, based on IEEE standard 802.3 section 28.2.3.1, Ethernet interface card 50a automatically determines hub 30 is operating in half-duplex mode. Thus, the IEEE standard 802.3 section 28.2.3.1 cannot determine if hub 30 is operating in full-duplex mode or half-duplex mode. Due to this duplex-mode ambiguity, Ethernet interface card 50a is configured to operate in half-duplex mode while hub 30 may be operating in full-duplex mode. Manual reconfiguration would be needed to place Ethernet interface card 50a in full-duplex mode to match the full-duplex mode of hub 30.

The duplex mode of hub 30 may be determined by placing Ethernet interface card 50a in full-duplex mode during the execution of the auto-negotiation protocol. Once in full-duplex mode, transmissions between hub 30 and Ethernet interface card 50a may be evaluated to determine the actual duplex mode of hub 30. Once determined, Ethernet interface card 50a may either remain in full-duplex mode or be automatically reconfigured to half-duplex mode, to match the communication mode of hub 30.

FLP signals include information to provide the speed at which hub 30 is transmitting data. For example after connecting to hub 30, Ethernet interface card 50a receives FLP signals from hub 30 providing the data transmitting speed of hub 30. By executing the auto-negotiation protocol, Ethernet interface card 50a determines and configures itself to match, as closely as possible, the transmitting speed of hub 30.

Data may be transmitted over Ethernet network 10 at various speeds. Typical Ethernet network transmission rates are 10 million bits per second (Mbps) and 100 Mbps, based on the IEEE 802.3 standard mentioned above. Thus, when executed, the auto-negotiation protocol will determine at which transmission speed hub 30 is operating, based on this IEEE standard. However, as mentioned above, the duplex-mode ambiguity of hub 30 remains.

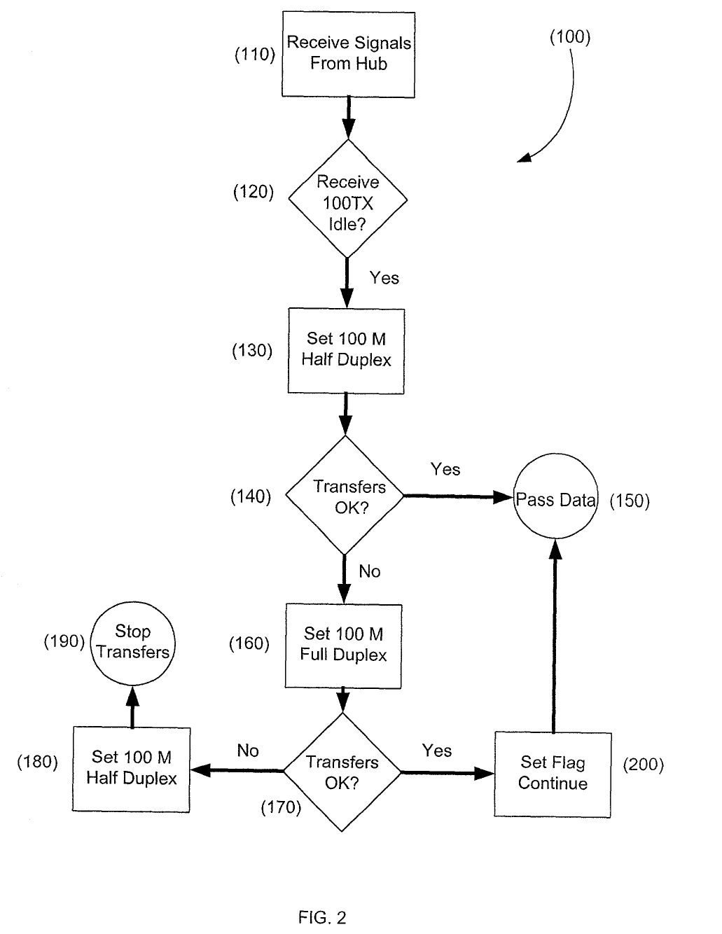

Referring to FIG. 2, in conjunction with the hardware shown in FIG. 1, a series of operations performed by an auto-negotiation protocol (100) are shown. In general, auto-negotiation protocol (100) receives signals (110) from hub 30, via Ethernet interface card 50a. Auto-negotiation protocol (100) determines if the signals are FLP signals, transmitted by hub 30 at an idle time (120). Once it is determined that the signals are FLP signals, transmitted at an idle time, auto-negotiation protocol (100) configures Ethernet interface card 50a to match the data transmitting speed of hub 30 and configures the Ethernet interface card 50a for half-duplex mode (130) operation. For example, if hub 30 transmits FLP signals, to signify a data transmitting speed of 100 Mbps, the FLP signals are received (110) and are sensed (120) by auto-negotiation protocol (100). After receiving the FLP signals, auto-negotiation protocol (100) configures Ethernet interface card 50a to transmit signals at 100 Mbps in half-duplex mode (130) over Ethernet network 10.

Auto-negotiation protocol (100) next determines if data is properly transferring between Ethernet interface card 50a and hub 30 while Ethernet interface card 50a is operating in half-duplex mode (140). For example, proper transferring may be determined if the data transfer error rate remains below a pre-determined threshold. If the data is transferring properly, auto-negotiation protocol (100) determines that hub 30 is transmitting data to computer 40a in half-duplex mode. In this case, auto-negotiation protocol (100) retains the configuration of Ethernet interface card 50a and continues to pass data (150) between computer 40a and hub 30 in half-duplex mode.

If auto-negotiation protocol (100) determines that data is not transferring properly (140) in half-duplex mode, the auto-negotiation protocol (100) assumes the reason for failure is that hub 30 is operating in full-duplex mode. Accordingly, Ethernet interface card 50a is reconfigured (160) to transmit data from computer 40a to hub 30 at the same transmission speed but in full-duplex mode.

After being reconfigured for full-duplex mode at, for example, 100 Mbps (160), data transfers between Ethernet interface card 50a and hub 30 are evaluated (170) to determine if data is properly transferring.

If auto-negotiation protocol (100) determines that data is properly transferring (170) in full-duplex mode, then a flag is set (200) to allow this duplex mode to be monitored by checking the flag and the data continues to pass (150) between computer 40a and hub 30 in full-duplex mode at, for example, 100 Mbps.

If the data transfers are not proper, auto-negotiation protocol (100) reverts Ethernet interface card 50a back to half-duplex mode (180) and data transferring is stopped (190). Thus, Ethernet interface card 50a retains the same state as if full-duplex mode had not been tested at all. This condition corresponds to no common communication mode being detected and auto-negotiation protocol (100) will not make a connection.

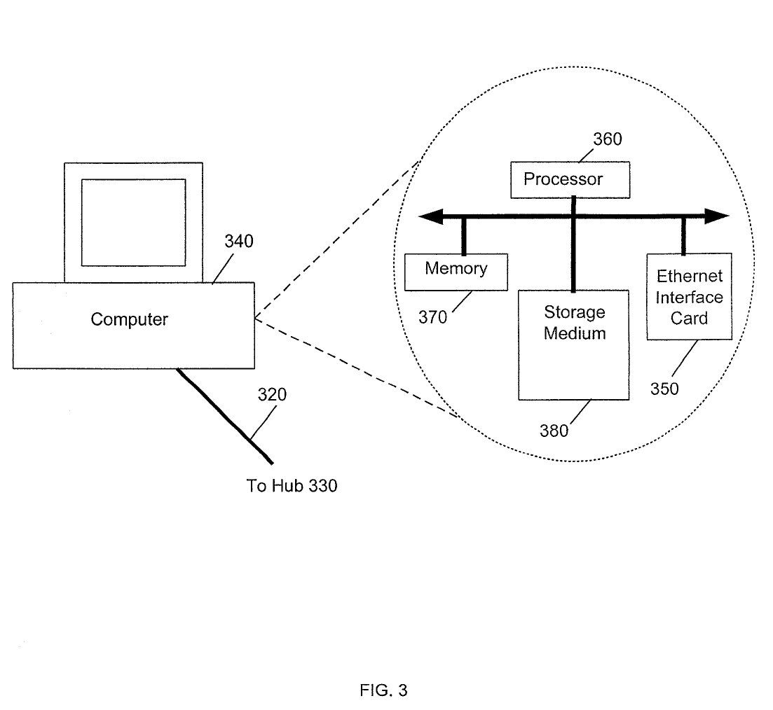

Referring to FIG. 3, computer 340 includes a memory 370 and storage medium 380 (e.g., a hard disk) that stores the instructions of auto-negotiation protocol (100). A processor 360 executes the instructions of auto-negotiation protocol (100) to configure an Ethernet interface card 350 for transferring data, over Ethernet cable 320, to hub 330.

In the example discussed above, in conjunction with FIG. 1, a computer 40a was included in the Ethernet network 10. However, other types of networks may utilize the computer 40a. For example, wide area networks (WAN), other types of local area networks, or other similar networks can include computer 40a. Also in conjunction with FIG. 1, hub 30 connected three computers 40a-c, however other devices may be included in Ethernet network 10 to provide these connections. For example, a switch or similar device may connect computers 40a-c. A switch may selectively transfer data between connected computers, in comparison to a hub which may broadcast received data to all connected computers. Ethernet network 10 may also include medium access controllers, Ethernet interface cards, computers, Ethernet peripheral devices, printers, or other similar devices in any combination.

Various types of transmission lines may be used to connect the various devices in Ethernet network 10. Ethernet cables 20a-c connect Ethernet network 10 shown in FIG. 1, however, thick coaxial lines, thin coaxial lines, twisted pair lines, fiber optic lines, or similar transmission lines may be used, individually or in combination, to connect Ethernet network 10. Wireless communication technology may also be used to link the various devices in Ethernet network 10. Infrared links, radio frequency links, or other similar transmission links may also be used individually or in combination, along with the transmission lines mentioned above, to connect Ethernet network 10.

In conjunction with FIG. 1, various devices, besides computer 40a, may be included in the Ethernet network 10. For example, medium access controllers, hubs, switches, or other devices may be connected with Ethernet cables and included in Ethernet network 10. Also, other types of computers, Ethernet interface cards, and Ethernet peripheral devices may also, individually or in combination, be included in Ethernet network 10.

The auto-negotiation protocol (100), described in conjunction with FIG. 2, is not limited to any particular hardware or software configuration; it may find applicability in any computing or processing environment. Auto-negotiation protocol (100) may be implemented in hardware, software, or any combination of the two. Auto-negotiation protocol (100) may be implemented in computer programs executing on machines (e.g., programmable computers) that each include a processor, a machine-readable medium readable by the processor (including volatile and non-volatile memory and/or storage elements), at least one input device, and one or more output devices. Auto-negotiation protocol (100) may also be implemented in an application specific integrated circuit (ASIC). Program code may be applied to the data, received from hub 330, to perform the auto-negotiation protocol (100) described and to generate output information. The output information may be applied to one or more devices, such as Ethernet interface card 350.

Each computer program may be implemented in a high-level procedural or object-oriented programming language to communicate with a computer system. However, the program products can be implemented in assembly or machine language, if desired. In any case, the language may be a compiled or interpreted language.

Each computer program may be stored on a machine-readable medium or device, e.g., random access memory (RAM), read only memory (ROM), compact disc read only memory (CD-ROM), hard disk drive, magnetic diskette, or similar medium or device, that is readable by a machine, e.g., a general or special purpose programmable computer, for configuring and operating the machine when the readable medium or device is read by the machine to perform auto-negotiation protocol (100). Auto-negotiation protocol (100) may also be implemented as a machine-readable storage medium, configured with a computer program, where, upon execution, instructions in the computer program cause the machine to operate in accordance with auto-negotiation protocol (100).

A number of embodiments of the invention have been described. Nevertheless, it will be understood that various modifications may be made without departing from the spirit and scope of the invention. For example, auto-negotiation protocol (100) may configure Ethernet interface card 50a for a communication mode that includes interleaving full-duplex and half-duplex modes. Accordingly, other embodiments are within the scope of the following claims.

What is claimed is:

1. A method of configuring communications over a network comprising:
connecting a device to the network;
receiving data on the device from the network;
configuring the device for a communication mode, from a plurality of possible communication modes, wherein the communication mode includes transferring data between the device and the network simultaneously in time;
transferring data between the device and the network based on the communication mode; and
determining whether to retain the device in the communication mode.

2. The method of claim 1 further comprising,
configuring the device for a communication mode, wherein the communication mode includes transferring data between the device and the network separately in time.

3. The method of claim 1, wherein communication mode further comprises a full-duplex mode.

4. The method of claim 1, wherein the network comprises an Ethernet network.

5. The method of claim 1, wherein the device comprises a medium access controller.

6. The method of claim 1, wherein the device comprises a switch.

7. The method of claim 1, wherein the device comprises a hub.

8. The method of claim 1, wherein the device comprises an Ethernet interface card.

9. The method of claim 1, wherein the device comprises a computer.

10. The method of claim 1, wherein the device comprises an Ethernet peripheral device.

11. An apparatus configured to connect to a network, the apparatus comprising:
a memory which stores instructions to,
configure the apparatus for a communication mode, from a plurality of possible communication modes, wherein the communication mode includes transferring data between the device and the network simultaneously in time,
transfer data between the apparatus and the network based on the communication mode,
determine whether to retain the apparatus in the communication mode; and
a processor which executes the instructions.

12. The apparatus of claim 11, wherein the instructions include configuring the apparatus for a communication mode, wherein the communication mode includes transferring data between the apparatus and the network separately in time.

13. The apparatus of claim 11, wherein the instructions include transferring data between the apparatus and the network in a full-duplex mode.

14. The apparatus of claim 11, wherein the network comprises an Ethernet network.

15. The apparatus of claim 11, wherein the apparatus is incorporated into a medium access controller.

16. The apparatus of claim 11, wherein the apparatus is incorporated into a switch.

17. The apparatus of claim 11, wherein the apparatus is incorporated into a hub.

18. The apparatus of claim 11, wherein the apparatus is incorporated into an Ethernet interface card.

19. The apparatus of claim 11, wherein the apparatus is incorporated into a computer.

20. The apparatus of claim 11, wherein the apparatus is incorporated into an Ethernet peripheral device.

21. An article comprising a machine-readable medium that stores instructions that cause a machine to:
receive data from a connected network;
configure the machine for a communication mode, from a plurality of possible communication modes, for transferring data between the machine and the network, wherein the communication mode includes transferring data between the machine and the network simultaneously in time;
transfer data between the machine and the network based on the determined communication mode; and
determine whether to retain the machine in the communication mode.

22. The machine-readable medium of claim 21, wherein the instructions further cause the machine to determine a communication mode, from the plurality of possible communication modes, wherein the communication mode includes transferring data between the machine and the network separately in time.

23. The machine-readable medium of claim 21, wherein the instructions further cause the machine to determine a communication mode, from the plurality of possible communication modes, wherein the communication mode includes transferring data between the machine and the network in a full-duplex mode.

24. The machine-readable medium of claim 21 is a random access memory.

25. The machine-readable medium of claim 21 is a read only memory.

26. The machine-readable medium of claim 21 is a hard disk drive.
